(19) United States
(12) Patent Application Publication
(10) Pub. No.: US 2014/0335502 A1
(43) Pub. Date: Nov. 13, 2014

(54) REAL-TIME VIDEO ANNOTATION LEARNING SYSTEM AND METHOD FOR THE SAME

(71) Applicant: NATIONAL CHENG KUNG UNIVERSITY, TAINAN CITY (TW)

(72) Inventors: YUEH-MIN HUANG, TAINAN CITY (TW); CHIA-JU LIU, TAINAN CITY (TW); HSIN-CHIN CHEN, TAINAN CITY (TW); MING-CHI LIU, TAINAN CITY (TW); TZU-CHIEN LIU, TAINAN CITY (TW); FU-YUN YU, TAINAN CITY (TW); YEN-HUNG KUO, TAINAN CITY (TW)

(73) Assignee: NATIONAL CHENG KUNG UNIVERSITY, TAINAN CITY (TW)

(21) Appl. No.: 14/026,296

(22) Filed: Sep. 13, 2013

(30) Foreign Application Priority Data
May 13, 2013 (TW) 102116867

(51) Int. Cl. G09B 5/02

(52) U.S. Cl. CPC G09B 5/02
USPC 434/430

(57) ABSTRACT

A real-time video annotation learning system and a method for the same are revealed. The real-time video annotation learning system includes a video management module, an annotation management module and a data storage module. A language learner can select videos stored in the data storage module by the video management module and add comments to a location of an image in the video at a specific time while the comments are in the form of text or graphs built in a commentary management module. Thus the comments are shown on the image in the form of text or graphs at a specific time. Users can grasp key points of learning content the video provided exactly. Together with system functions of real-time word look-up and word note, user's learning effect is significantly improved and the video has an advantage in language learning.

### BACKGROUND OF THE INVENTION

1. Fields of the Invention

The present invention relates to a real-time video annotation learning system and a method for the same, especially to a video used as teaching materials in which learners can attach commentary such as text or graphs to a location in the video at the time point they required while the video being displayed. Thus the commentary is displayed on the image in the form of text or graphs at the specific time learners required. Therefore learners can grasp main points in the video exactly.

2. Descriptions of Related Art

The advanced information technology has been deeply infiltrated into our daily lives due to globalization. People have overcome time and distance constraints and communications in multicultural environments are more frequent. This means more exchange and transferring among different languages. The language itself reflects cultural values and specificity. Thus learning language has great help in determining cultural concepts. Moreover, audiovisual media has been the most popular product all over the world and the application of audiovisual media to teaching materials for language learning becomes a trend in language learning. The advanced internet technology also brings users many possibilities and convenience. A great amount resources shared inside a virtual world of the internet also provide users learning experience with lots of unlimited opportunities. Some research indicated that the use of video learning resources allows learners to take responsibility for their own learning (Learner Autonomy). If teachers can introduce media technology into learner's language learning, not only the learner's motivation and interest are raised, the learning effect of different learning requirements is also enhanced. Videos are one of the multimedia products represented by simulation of actual situations. Through different pictures of the actual situations, images in learner's mind are memorized more effectively and the linking of knowledge is enhanced. The applications of video to language learning achieve certain effects. Thus the video is always hot teaching material for learning foreign language. By the video, learners can have a foreign-language speaking environment to preview and review course content at the time they need. There is no need to have teachers on the scene. The video not only increases learner's motivation and interest but also facilitates learner's understanding about foreign languages.

Although the video attracts language learners' attention, there are still certain negative effects. During display process of the video, the learners are unable to receive such large amount of information within a short period of time effectively so that the learning effect is poor. According to cognitive load theory, the learning video brings the learner extraneous cognitive load and further affects their psychological activities and knowledge construction. Thus the learning effect is greatly reduced. Moreover, once the video content is complicated or the display speed is too faster, the learners can hardly grasp the points. Thus there is a need for video material vendors or educators to find a solution to solve the problem of extraneous cognitive load, make the learners grasp main points of the video, and allow the video has an advantage in learning.

### SUMMARY OF THE INVENTION

Therefore it is a primary object of the present invention to provide a real-time video annotation learning system and a method for the same by which learners can add comments to a location of an image in a video at a specific time while displaying the video. Thus the comments are shown on the image in text or graphic form at the specific time and users can grasp key points of learning content the video provided exactly.

In order to achieve the above object, a real-time video annotation learning system of the present invention includes a video management module, an annotation management module and a data storage module. The video management module is for learners to manage the videos they need. The video includes a plurality of frame each of which is corresponding to a time point of a timeline. The video management module is composed of a video addition interface, a video deletion interface and a display interface. As to the annotation management module, it consists of a graphical annotation interface and an annotation track interface. The graphical annotation interface allows learners to add commentary to a certain location in an image of the video and records the time point corresponding to the commentary added. The annotation track interface is for learners to click and review the video at the time point corresponding to the commentary attached. The data storage module has a video database and a commentary database associated with the video database. The video database is for learners to store the videos while the commentary database is used to store the commentary added. Thereby learners can add commentary in the form of text and graphs to the location in the video at the specific time point while displaying the video by means of the real-time video annotation learning system. Thus the text or graphic commentary is shown on the image at the specific time point and the learners can grasp the learning content and main points in the video exactly. Therefore the video has an advantage in language learning. Moreover, by a design of an open platform, language learners can add comments to the video online so as to share their comments and cooperate with others for annotation.

The commentary the learner attached is stored in XML file format in the commentary database. The display interface shows the commentary on the image at the specific time point according to the information recorded in the XML file.

Furthermore, the annotation management module is further disposed with a dictionary interface by which the learner can look up words and make notes of words simultaneously while watching the video.

In addition, the graphical annotation interface built in the annotation management module includes a pencil tool, a line tool, a rectangle and circle tool, a text addition tool and an eraser tool. The learners draw free hand lines on the screen by the pencil tool. The line tool is to draw lines and label the main points. The rectangle and circle tool helps learners label the key points in the video by different shapes. The text addition tool allows the learners to add a text element to the image while the eraser tool is to delete the commentary they don't need. Moreover, each tool allows learners to select different colors so that the commentary with text and graphs is more colorful.

A method for real-time video annotation learning includes a plurality of steps. First, a display interface of a video management module is used to select a video from a video database for display. At last, commentaries in text or graphic form are added to a location in a video by a graphical annotation interface of an annotation management module to record a time point corresponding to the commentary by a commentary database, while learners watching the video. In such a case, learners can select and review the video at the time point corresponding to the added commentary by an annotation track interface. In each step, the learners add commentary by the video management tool and the annotation management respectively while the commentary can be used as a clue to remind learners of the content of the video. Thus the method for real-time video annotation learning can solve the problem of conventional learning video that brings the learners extraneous cognitive load, allowing learners to grasp the learning content and the main point underlying through the commentary. The video further has an advantage in language learning.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing structure of an embodiment of a real-time video annotation learning system according to the present invention;

FIG. 2 is a schematic drawing showing a user interface of an embodiment of a real-time video annotation learning system according to the present invention;

FIG. 3 is a flow chart showing steps of an embodiment of a method for real-time video annotation learning according to the present invention.

### DETAILED DESCRIPTION OF THE PREFERRED EMBODIMENT

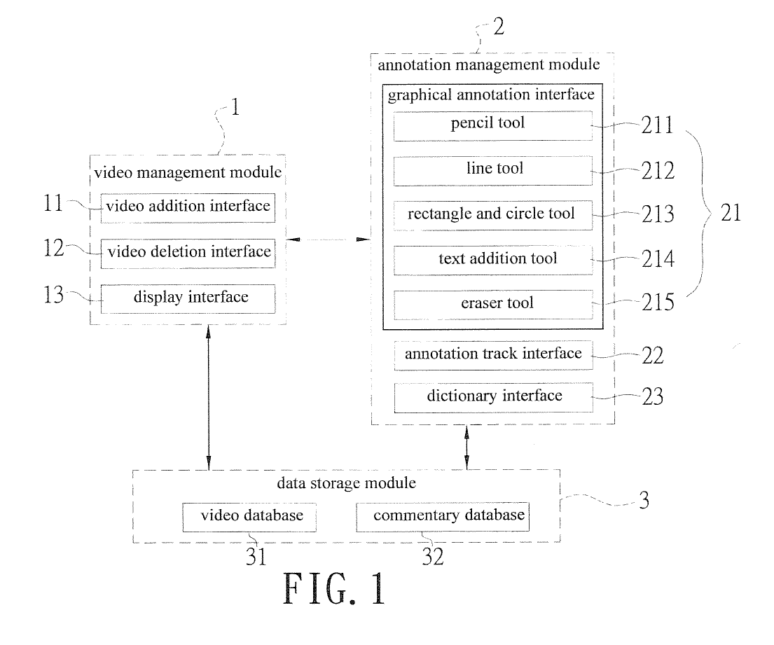

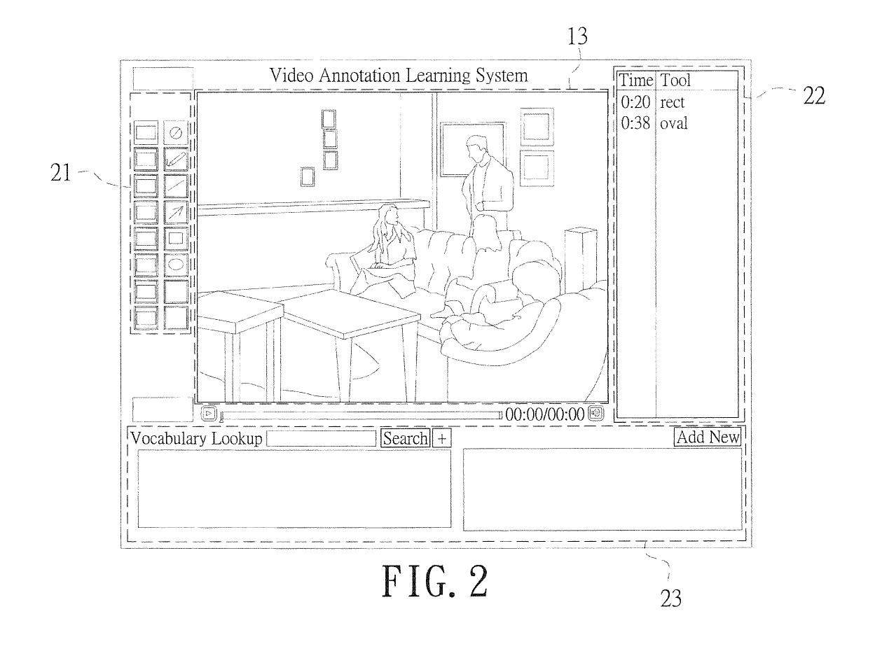

The basic concept of annotation is described. Annotation is an important strategy in learning activities. During processes of knowledge construction, learners add notes/commentary to learning materials for expressing their ideas and questions and being used as summary or reminder. This helps learners to code and memorize effectively. Besides reducing cognitive load while the learner reviewing learning content, the notes on video teaching materials in a learning system with an open architecture have a high value for learning and used as reference for other learners while learning the same content. By adding commentary to the video on-line, not only non-synchronous video annotation can be shared at time and place the learner required, the learner can also review and learn other's notes while watching the video. The leaner's mind can jump from one thought to the other quickly along with the video commentary so as to have a greater learning effect with less effort. Refer to FIG. 1 and FIG. 2, a block diagram showing arranged of modules of a real-time video annotation learning system according to the present invention and a schematic drawing showing a user interface are revealed. The real-time video annotation learning system includes a video management module 1, an annotation management module 2 and a data storage module 3.

The video management module 1 is used for learners to manage the videos they need. The video includes a plurality of frames each of which is corresponding to a time point of a timeline. Thus the video is formed by each frame corresponding to each time point of the timeline. The video management module 1 consists of a video addition interface 11, a video deletion interface 12 and a display interface 13. The leaner can add new learning videos by using the video addition interface 11 while the video deletion interface 12 is for deletion of the videos learners doesn't need any more. The display interface 13 is used to play the videos for learning languages.

The annotation management module 2 is composed of a graphical annotation interface 21 and an annotation track interface 22. The graphical annotation interface 21 enables learners to add commentary to a certain location in the video and records the time point corresponding to the commentary added. As to the annotation track interface 22, it is for the learner to click and review the video at the time point corresponding to the commentary attached.

The data storage module 3 includes a video database 31 and a commentary database 32 associated with the video database 31. The video database 31 is for learners to store the videos while the commentary database 32 is used to store the commentary attached.

The commentary the user attached is stored in XML file format in the commentary database 32. The display interface 13 built in the video management module 1 displays the commentary on the image at the specific time point according to the information recorded in the XML file.

Moreover, the annotation management module 2 is further disposed with a dictionary interface 23 by which the learner can look up words and make notes of words simultaneously while watching the video.

The graphical annotation interface 21 built in the annotation management module 2 includes a pencil tool 211, a line tool 212, a rectangle and circle tool 213, a text addition tool 214 and an eraser tool 215. The pencil tool 211 allows learners to draw free hand lines on the screen. The line tool 212 is to draw lines and label the main points. The rectangle and circle tool 213 helps learners label the key points in the video by different shapes. The text addition tool 214 allows learners to add a text element to the image while the eraser tool 215 is for learners to delete the commentary they don't need. Moreover, each tool allows learners to select different colors so that the commentary with text and graphs is more colorful.

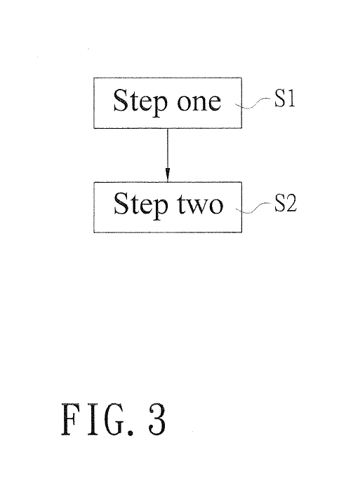

Refer to FIG. 3, a flow chart of a method for real-time video annotation learning including following steps according to the present invention is revealed.

Step one (S1): use a display interface 13 of the video management module 1 to select a video from a video database 31 for display by a learner; the leaner can also either use a video addition interface 11 to add new videos, or use a video deletion interface 12 to delete videos; and

Step two (S2): add commentary in text or graphic form to a location in a video by a graphical annotation interface 21 of an annotation management module 2 and record a time point corresponding to the commentary in a commentary database 32 while the leaner watching the video so that the learner can select and review the video at the time point corresponding to the attached commentary.

In summary, a real-time video annotation system and a method for the same according to the present invention have following advantages compared with techniques available now:

1. The real-time video annotation learning system and the method for the same of the present invention allows users to add commentary to the videos for learning languages by attaching text, graphs or figures to a time-specific location in the video. Thus learners can grasp the learning content and key points underlying and the video further has an advantage in language learning.

2. The commentary the learner attached can also be used as a clue to recall the content of the video.

3. By the design of an open platform, the users that learn languages by videos on line can add commentary to the video freely. Thus the users are allowed to share their commentary with others and have collaborative annotation.

4. The commentary is integrated into the video by text addition and various graphic tools. While watching the video, the users can also use additional functions the system provides including video index, word look-up and word note.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A real-time video annotation learning system comprising:
a video management module used for learners to manage videos they used and the video management module having a video addition interface, a video deletion interface and a display interface; a video includes a plurality of frames and each frame is corresponding to a time point of a timeline;
an annotation management module having a graphical annotation interface and an annotation track interface; the graphical annotation interface allows the learners to add commentary to a certain location in the video and records a time point corresponding to the commentary added while the annotation track interface is used for the learners to click and review the video at the time point corresponding to the commentary added; and
a data storage module that includes a video database and a commentary database associated with the video database; the video database is for the learners to store the videos while the commentary database is used to store the commentary added.

2. The system as claimed in claim 1, wherein the commentary added is stored in the commentary database in XML file format; the display interface displays the commentary on the frame at the time point according to information recorded in the XML file.

3. The system as claimed in claim 1, wherein the annotation management module is further disposed with a dictionary interface by which the learners can look up words and make notes of words simultaneously while watching the video.

4. The system as claimed in claim 1, wherein the graphical annotation interface includes a pencil tool, a line tool, a rectangle and circle tool, a text addition tool and an eraser tool; the pencil tool allows the learners to draw free hand lines on a screen; the line tool is to draw lines and label the main points; the rectangle and circle tool helps the learners label main points of the video; the text addition tool enables the learners to add a text element; the eraser tool allows the learners to delete the commentary they don't need.

5. A method for real-time video annotation learning comprising the steps of:
step one: using a display interface of a video management module to select a video from a video database for display; and
step two: adding commentary in text or graphic form to a location in a video by a graphical annotation interface of an annotation management module and recording a time point corresponding to the commentary by a commentary database while learners watching the video so that learners can select and review the video at the time point corresponding to the added commentary by an annotation track interface.

6. The method as claimed in claim 5, wherein the commentary added is stored in the commentary database in XML file format; the display interface displays the commentary on the frame at the time point according to information recorded in the XML file.

7. The method as claimed in claim 5, wherein the annotation management module is further disposed with a dictionary interface by which the learners can look up words and make notes of words simultaneously while watching the video.

8. The method as claimed in claim 5, wherein the graphical annotation interface includes a pencil tool, a line tool, a rectangle and circle tool, a text addition tool and an eraser tool; the pencil tool allows the learners to draw free hand lines on a screen; the line tool is to draw lines and label the main points; the rectangle and circle tool helps the learners label main points of the video; the text addition tool enables the learners to add a text element; the eraser tool allows the learners to delete the commentary they don't need.
